(19) United States
(12) Patent Application Publication
(10) Pub. No.: US 2007/0006923 A1
(43) Pub. Date: Jan. 11, 2007

(54) Adjustable inlet valve with air gap

(76) Inventor: John William Smith, Victoria (AU)

Correspondence Address: WEGMAN, HESSLER & VANDERBURG, 6055 ROCKSIDE WOODS BOULEVARD, SUITE 200, CLEVELAND, OH, 44131, US

(21) Appl. No.: 10/573,149

(22) PCT Filed: Sep. 24, 2004
(86) PCT No.: PCT/AU04/01304

§ 371 Date: Mar. 22, 2006

(30) Foreign Application Priority Data
Sep. 26, 2003 (AU) 2003905260

(51) Int. Cl. F16K 31/18

(52) U.S. Cl. 137/426; 137/440

(57) ABSTRACT

A valve arrangement for use in the cistern (8) of a toilet is described having an inlet valve (20) operated by a float (46) such that when the level of water in the cistern reaches a threshold amount, the float operates the inlet valve to substantially instantaneously close the supply of incoming water. The inlet valve of the valve arrangement is provided with an air gap or clearance (51) to eliminate, prevent or reduce siphoning of water from the cistern into the water supply when the valve is in the fully closed position. The air gap allows water within the inlet valve to drain into the cistern so as to form the air gap.

The present invention relates generally to valves for controlling the flow of fluid. One particular form of the valve is an inlet valve which controls movement of liquid through the valve so as to replenish or maintain supply of the liquid. A particular form of the inlet valve controls replenishment of the cistern of a toilet after flushing or similar installation or reservoir of water by controlling the flow of water into the cistern to replace the recently discharged water so as to replenish the cistern for future use in such a manner so as to prevent unwanted siphoning of water through the inlet valve back to the water supply such as the mains pressure supply thereby preventing, eliminating or reducing the opportunity for the water supply being contaminated with water from the cistern such as for example, preventing back flow of the water already in the cistern into the mains.

The present invention find particular application as an inlet valve of a toilet cistern or similar having an air gap arrangement preventing back siphoning of water. In one preferred application the inlet valve has an air gap for controlling the introduction of water into the cistern after flushing in which the inlet valve is provided with a moveable valve member allowing air to pass through the valve when the valve member is closed, such as for example, when the cistern is in a storage condition. The air gap prevents siphoning of water back into the mains pressure water supply system so that the water in the inlet tube of the cistern for supplying water to the inlet valve automatically flows out of the valve to lower the water level in the cistern thereby creating an air lock that prevents siphoning of the water.

Another application and/or advantage of some forms of the inlet valve of the present invention, including the particular forms referred to above, is as an adjustable height valve having a flexible conduit extending between the inlet of the cistern for admitting replacement water to the cistern and the inlet valve itself for controlling flow of the water into the cistern so that the valve can be selectively adjustable in height so as to be capable of being fitted to a wide range of differently sized, shaped, styled and types of cisterns to satisfy the requirements of regulatory authorities.

Although the present invention will be described with particular reference to one form of an inlet valve for controlling flow of replenishing water into a cistern it is to be noted that the scope of the present invention is not restricted to the described embodiment of the inlet valve or the particular application of the inlet valve or even to inlet valves but rather the scope of the present invention is more extensive so as to include other forms of the valve arrangement, the use of the various different forms of the valves and inlet valves in other applications, such as for example, in controlling the flow of fluids generally, and liquids in particular in industry in general, in the chemical industry, manufacturing industry or the like, and to different arrangements of the moveable valve member and to different relationships between the moveable valve member and the valve body of the inlet valve, and to different ways of forming the air gap that is responsible for reducing, eliminating, preventing or the like siphoning of the water out of the cistern.

The present invention will be described with reference to forms of inlet valves and the use of the valve or valves in cisterns for ease of understanding and clarity of description.

Cisterns in use for flushing a toilet come in a variety of different sizes, shapes, configurations, types and arrangements. However, almost all cisterns have an inlet valve for controlling the flow of incoming water into the cistern to replenish the supply of water after flushing. Existing inlet valves suffer from one or more defects, some more serious than others. One defect of existing inlet valves is that they are noisy in operation, particularly as the last of the water supply is being replenished and the inlet valve is almost closed or very gradually moving to the fully closed position. Another defect is not being able to completely shut off the inlet valve in order to staunch the flow of incoming water. Valves which close poorly or slowly or have a poor seal are manifest by water continually leaking into the toilet bowl through the overflow of the cistern.

Other inlet valves are large and complicated having a complex arrangement of many moving parts. Such valves are overly complicated and often require repeated replacement of the valve at frequent intervals due to wear and tear of the various moving parts to ensure sealing of the cistern and full closure of the inlet valve. In many instances the unreliable valves can only be replaced by the same or similar valves which are themselves inherently unreliable thereby leading to further premature replacement. Owing to the configuration of the cistern and/or valve it is often not possible to use a different type of replacement valve such as for example a more reliable type of replacement valve. Thus, the problems of currently available inlet valves are continued by replacing such valves with valves of a similar type or size. Thus, there is a need for a more universally acceptable inlet valve having more flexible design characteristics that can be used to replace a wider variety of different inlet valves in which the more universally acceptable valve is less complicated or complex than the valve it is replacing and has a lower number of moving parts, and/or has better sealing characteristics.

Another problem of some existing inlet valves involves the structure of the valves. The authorities governing the use of inlet valves in cisterns increasingly require that the valves do not allow siphoning of water within the cistern and require an air gap to be developed or present in the cistern, particularly when the cistern is in a full condition, after filling such as in a storage condition prior to being flushed. If no air gap is provided there is the possibility that in some circumstances water can flow from the cistern into the mains supply leading to the possibility of contamination of the water in the mains supply. Many older type valves do not satisfy this relatively recent requirement. Thus, when older style valves not having an air gap require replacing there is a need for the replacement valves to have an air gap facility. However, owing to the size, shape and style of many older cisterns many newer valves having the air gap facility can not be used as replacement valves since they will not fit in place of the older valves. Thus, there is a need for a more universal valve having an air gap capability or facility that can be used to replace older valves not having or providing an air gap within the cistern. If the inlet valve is not provided with an air gap there is a chance that in some circumstances water will flow from the cistern back into the mains supply thereby risking contaminating the main supply water.

It is also desirable that the newer air gap valves be adjustable in size so as to be able to be used in a wider variety of different cisterns in order to provide the air gap facility when required to satisfy regulations or when replacing older valves.

Thus, one aim of the present invention is to provide an inlet valve which is more universal in its application as a replacement for existing valves or can be used in a wide variety of different shaped or styled cisterns.

Another aim of the present invention is to provide a valve which is adjustable in size, particularly adjustable in height or length, which can be selectively adjusted to fit a wide variety of different cisterns, such as, for example as a retro fit to replace existing valves so as to satisfy more recently introduced regulations.

Another aim of the present invention is to provide a valve having an air gap capability or being able to develop an air gap so as to prevent siphoning of water from the cistern back to the water supply.

It is to be noted that not all valves of the present invention must satisfy all of the aims of the present invention. Different embodiments of the inlet valve of the present invention can address different aims. Further some forms of the valve can address one or more of the aims.

According to one aspect of the present invention there is provided an inlet valve controlling introduction of fluid into a vessel, said vessel forming a reservoir for the fluid and having an inlet admitting replacement fluid from a fluid supply into the vessel to replace fluid discharged from the vessel by flow of fluid from the supply inlet of the vessel through the inlet valve, said inlet valve comprising a valve body member and a moveable valve element that is moveable with respect to the valve body member between a first position corresponding to a closed condition preventing flow of fluid through the inlet valve and a second position corresponding to an open condition allowing flow of liquid through the inlet valve to replenish or replace the supply of fluid within the vessel after discharge of fluid from the vessel wherein there is clearance portion associated with either the valve body member or the moveable element, said clearance portion being arranged such that when the moveable element is in the closed position within the inlet valve there is a space or gap between the movable element and the valve body member allowing flow of gas into and/or through the valve between the moveable element and the valve body member so as to provide a facility of or for a gas gap in the valve wherein the gas gap prevents unwanted flow of liquid from the vessel into the supply fluid when the inlet valve is in the closed position.

Typically, the vessel may be a vessel of the type used in industrial processes, manufacturing operations, in the chemical industry, in the food and beverage industries or the like. More typically, the vessel is a reservoir holding tank, storage vessel or the like. Even more typically, the vessel is a cistern of a toilet. Even more typically, the cistern is a flushing cistern having a dual flush valve providing two different modes of operation of the valve, one being a full flush whereas the other is a partial flush.

Typically the inlet valve of the present invention may be fitted as original equipment to cisterns or may be retro fitted to existing cisterns or may be used as a replacement inlet valve for existing inlet valves in a wide variety of different size, shape, style or type of cisterns. It is to be noted that most of the operable parts of the inlet valve of the present invention are located above the level of water in the cistern, even when the cistern is full so that the chance of contamination, damage, corrosion of the parts is reduced, minimised or the like.

More typically, the valve is adjustable in size, preferably adjustable in height and/or length. Additionally, the valve may be also adjustable in width or the foot print of the valve may be adjustable, typically, being adjustable side ways including combinations of being adjustable.

Even more typically, the valve is provided with an adjustable support member, preferably a support member that allows the valve to be mounted on the support member at different heights as required. More typically, the support member has fastening means, preferably spaced apart fastening means. More preferably, the spaced apart fastening means include a plurality of spaced apart apertures and a removable pin or a clip arrangement or similar that can be selectively replaceably secured to adjust the size and/or height of the valve. Even more typically, the support member is part of the outlet valve, typically a dual flush or dual mode valve. More typically, the position of the inlet valve is adjustable with respect to the outlet valve, preferably being sideways adjustable and more preferably being rotationally adjustable.

Typically the moveable valve element is a substantially elongate member or similar. More typically, the elongate member is a plunger. Even more typically, the plunger is a substantially cylindrical rod, bar, shaft or similar. Even more typically, one end of the rod is curved, rounded, tapered, beveled or the like. Even more typically the rounded end of the rod is the sealing end for sealingly maintaining the valve in a closed condition, particularly in conjunction with a sealing ring, o-ring or similar complementary sealing means. Typically, the other end of the rod is connected to a lever, preferably an operating lever including a straight lever, an articulated lever, or combinations of operating levers.

More typically the plunger is connected directly or indirectly to the lever or one of the levers. Even more typically, there may be one, two, three, four or more levers interconnected together to form an operating mechanism. Even more typically, the other end of the plunger is provided with a connector, preferably a connector block which connects the plunger to the or one of the levers, preferably the distal end of one of the levers.

Typically the clearance portion is a space, gap, looseness of fit, clearance, cut out, rebate, groove, indent or similar. More typically, the clearance portion or the like is located along the length of the plunger, preferably at or towards the central portion or region of the plunger. More typically, the clearance portion is located at or towards one end of the plunger, preferably towards the upper end in use or the end remote from the sealing end of the plunger i.e. at or towards the end connected to the lever, rather than the end that seals the inlet valve into a closed condition. Even more typically, the clearance portion of the plunger is of a size that is relatively smaller or reduced when compared to the size of the main portion i.e. is a neck portion or waist portion or the like.

Typically, the clearance portion is located on or around the outside surface of the plunger. More typically, the clearance portion is a reduced diameter rebate, groove, channel, cut out or the like, more or less circumferentially arranged around the main portion of the plunger. More typically the clearance portion is a neck or waist region of reduced diameter. Even more typically the profile of the neck portion or waist portion is tapered towards either end. Even more typically the neck or waist portion is axially aligned along the plunger.

Even more typically, the neck portion or waist portion is an elongate slot or slit or channel or the like.

Typically the groove, etc. is continuous extending substantially all the way around the circumference of the rod or is discontinuous having spaced apart segments defining gaps or spaces therebetween or other combinations.

Typically, the plunger is associated with a plunger guide or housing or shroud. More typically, the clearance portion is associated with the guide. Even more typically, the guide is provided with a cut out, groove, channel reduced wall portion of the like. Even more typically, the plunger guide is provided with an internal bore. Preferably, the internal bore is provided with an elongate channel, more preferably, the channel extends lengthwise of the bore in the wall of the bore. Even more typically, the guide allows the plunger to substantially freely move with respect thereto. Even more typically, the guide is provided with a slot, channel, groove, rebate, bore, air way, port, aperture, hole or the like so that air can pass between the plunger and the guide to form the air gap and air can pass from outside the inlet valve through the valve to form the air gap. Typically, the plunger guide is provided with an axial channel or similar and a radial port, channel, groove, bore, aperture or similar.

Typically the inlet valve is connected to the inlet of the cistern by a conduit. More typically the conduit is a flexible conduit. Even more typically the flexible conduit is a tube, hose, or similar allowing the distance between the inlet and the inlet valve to be varied, preferably in accordance with the height or length of the valve, and in accordance with sideways movement of the valve.

Typically, the inlet can be located at the top, along the side, in the base or at any other position within the cistern. More typically, the inlet is horizontally oriented or vertically orientated within the cistern.

Typically the position of the inlet valve is adjustable with respect to the inlet of the cistern. More typically the inlet valve is longitudinally adjustable along the lengthwise extending axis of the valve so as to alter the height of the inlet valve. Even more typically, the inlet valve is rotationally adjustable, preferably, rotatably adjustable about two different parts of the inlet valve structure to provide even greater rotational adjustability.

Typically the inlet valve includes an element responsive to changes in the water level within the cistern. More typically the responsive element is buoyant or acts under the effect of buoyancy and or gravity. Even more typically the responsive element is a float. Even more typically the float is connected either directly or indirectly to the moveable valve element so that movement of the float causes corresponding movement of the moveable valve element to open and close the inlet valve accordingly. Even more typically, the float is connected to one or more levers and then to the movable valve element.

Typically the float moves with a flip action or positive snap action to instantaneously close the supply of incoming fluid or water. More typically, the float is located off centre so as to pivot about a fulcrum. More typically, the off centre location of the float causes it to flip or snap closed positively.

Typically the valve body member has a bore within which is received the plunger, typically one end of the plunger.

Typically the plunger moves axially within the bore. More typically, the plunger moves axially about 4 mm or so. Typically the plunger moves freely within the bore as there is a clearance fit of the plunger in the bore allowing passage of gas admitted through the clearance portion to pass into a cavity or chamber defined within the valve body member. More typically, the cavity or chamber is in fluid communication with an outlet of the valve. Even more typically the flow of gas, typically air, admitted through or by the clearance portion and through the valve body constitutes a gas gap or air gap preventing unwanted flow of water through the valve into the main supply i.e. prevents siphoning.

Typically the gas is air and the gas gap is an air gap. More typically, the air gap prevents siphoning of water through the valve to the mains reducing or preventing contamination of the mains supply i.e. is an anti-siphoning device.

Typically, the inlet valve is located above the maximum fill level of the cistern so that the inlet valve is always above the level of the water in the cistern. More typically, when the cistern is full and the inlet valve closed there is an outlet provided in the inlet valve through which water in the inlet valve can flow into the cistern, typically through the outlet of the valve to lower the level of water in the valve thereby creating the air gap between the inlet valve and the top of the level of water in the cistern.

Typically, the outlet of the inlet valve is located substantially vertically, or substantially horizontally. More typically, the outlet is located substantially vertically downwardly directed. Alternatively the outlet is downwardly directed at some point along its length. Typically the outlet is provided with a terminal fitting.

Typically, the terminal fitting is a rose shower nozzle delivery fitting or the like for dispensing and/or discharging water from the inlet valve.

The present invention will now be described by way of a non-limiting example with reference to the accompanying drawings in which:

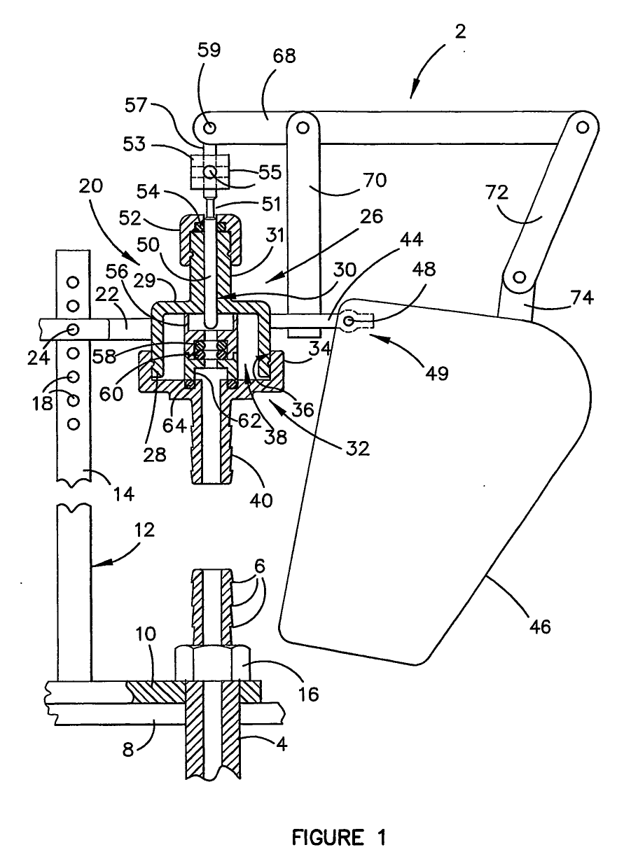

FIG. 1 is a side elevation view of one form of an overall valve arrangement incorporating one form of the inlet valve of the present invention shown in the open position allowing the flow of water into the cistern in which the valve arrangement is located.

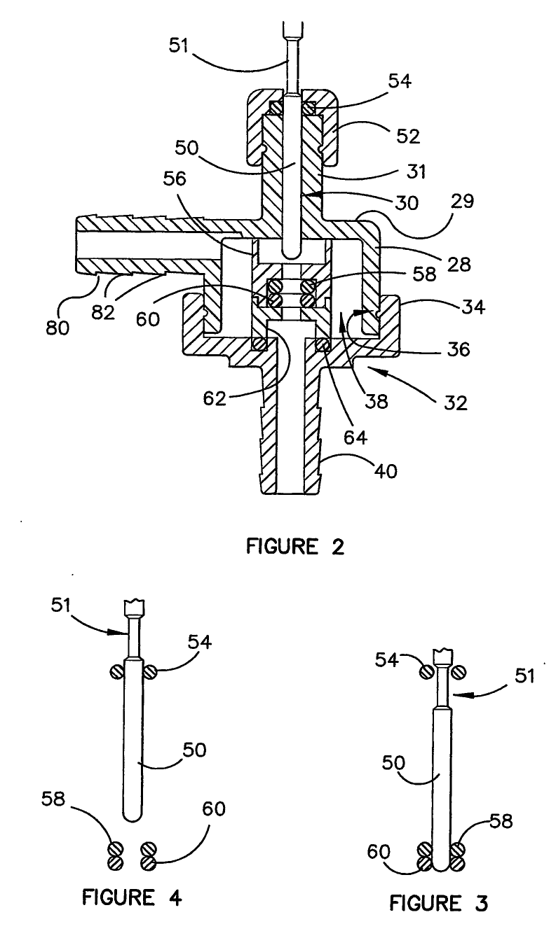

FIG. 2 is a side view of the inlet valve portion of the valve arrangement shown in FIG. 1 rotated through about 90° so as to illustrate the location of the outlet nozzle but omitting the plunger for sealing the inlet valve when in the closed position.

FIG. 3 is a side elevation view of one form of the moveable valve element in the form of a plunger in a closed position in which the end of the plunger is sealed by a pair of spaced apart “O” rings and the clearance portion is arranged to allow admission of air into the valve.

FIG. 4 is a side elevation view of the same form of the moveable air element as illustrated in FIG. 3 in the form of a plunger when in an open position with the end of the plunger spaced from the pair of “O” rings allowing water to flow into the cistern past the end of the plunger.

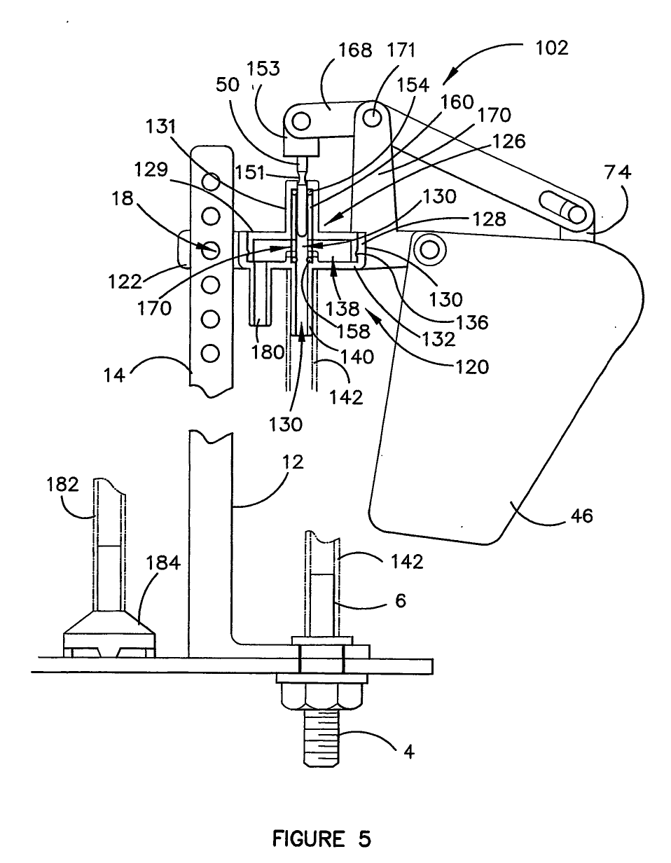

FIG. 5 is a side elevation view of another form of the overall valve arrangement incorporating another form of the inlet valve of the present invention shown in the open position.

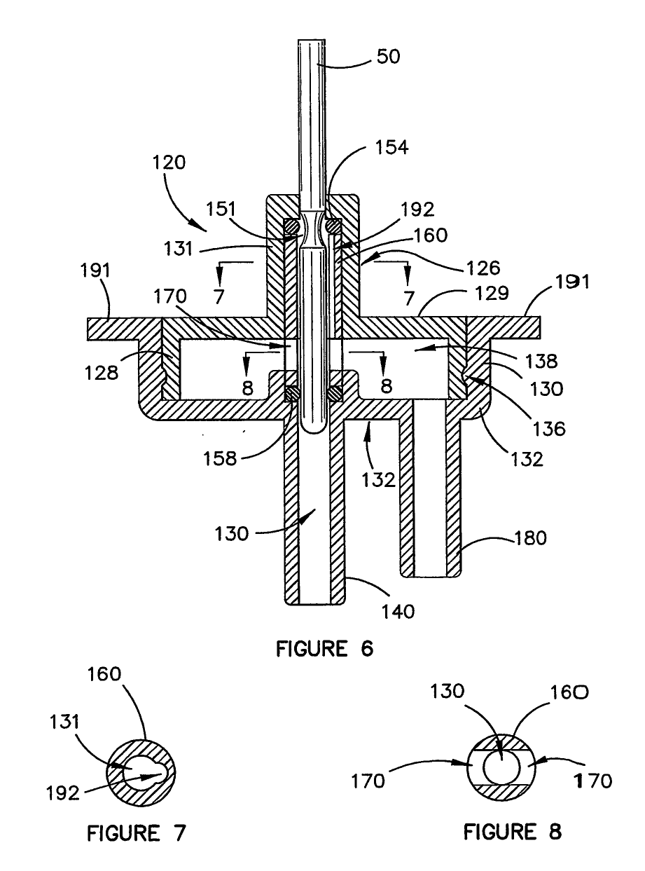

FIG. 6 is a vertical cross-sectional view of the form of the inlet valve of FIG. 5 when in the closed position with the end of the plunger received between a sealing “O” ring.

FIG. 7 is a horizontal cross sectional view taken along the line 7 to 7 of FIG. 6, and

FIG. 8 is a horizontal cross sectional view taken along the line 8 to 8 of FIG. 6.

In FIG. 1 there is shown one form of the valve arrangement incorporating one form of the inlet valve of the present invention controlling introduction of water into a cistern after flushing. In FIG. 1 the inlet valve part of the overall valve arrangement is in the open position allowing water to flow through the valve into the cistern. The valve arrangement generally denoted as 2, includes an inlet nozzle 4 through which replacement water from the mains pressure water supply is introduced into the cistern to replenish the cistern once the toilet has been flushed after use. Inlet nozzle 4 has a plurality of spaced about circumferential ribs 6 located at different intervals along the length of the nozzle. Nozzle 4 is provided with a tapered end or tip for receiving one end of a flexible conduit or hose (not shown) which is frictionally fitted over ribs 6 to securely hold the hose in place on the inlet nozzle. The inlet nozzle 4 is received through an aperture in the lower wall 8 of the cistern. The lower wall 8 of the cistern is shown in fragmentary form in FIG. 1. Nozzle 4 also passes through an aperture located in foot 10 of a T-shaped or L-shaped bracket 12 having post 14 extending upright from foot 10. Bracket 12 is arranged such that the aperture of lower wall 8 and the aperture provided in foot 10 of bracket 12 are in register with each other for receiving therethrough inlet nozzle 4. A suitable fastening means in the form of a nut 16 securely fastens the inlet nozzle 4 and bracket 12 in place in engagement with lower wall 8 to securely anchor bracket 12 in the cistern.

Support bracket 12 is for supporting the inlet valve of the present invention, generally denoted as 20. Post 14 is provided with a plurality of spaced apart apertures 18 for receiving a pin (not shown) therethrough to mount inlet valve 20 at a desired or selected height on post 14 depending upon requirements. Valve 20 is provided with a radially outwardly extending arm 22 having an aperture 24 located at or towards the distal end of the arm. When the aperture 24 of arm 22 is aligned with one of the apertures 18 of post 14 a pin can be received through the aligned apertures 18, 24 to mount or attach valve 20 to support bracket 12 at the desired height in order for the valve arrangement 2 to be accommodated in the particular type, style or size cistern in which it is desired to mount the valve. Additionally or alternatively, valve 20 can be rotatably adjusted with respect to post 14 to adopt any desired orientation as required.

The proximal end of arm 22 is attached to a generally cylindrical valve body 26 of inlet valve 20. Valve body 26 has a cylindrical downwardly depending side skirt 28 which is arranged to form together with end wall 29 a relatively larger diameter inverted cup and a generally elongate upper part 31 which extends axially upwardly in use from end wall 29 so as to form a relatively smaller diameter extension section having a bore 30 located therein within which plunger 50 is axially moveably located. The movement of plunger 50 will be described later in this specification.

The valve 20 is also provided with a generally circular body base 32 also having a cup like form and having an upper flange portion 34 of relatively greater diameter than the diameter of skirt 28. Flange 34 is of a relatively larger diameter than skirt 28 so that skirt 28 is sealingly received within flange 34 so as to form the valve body. A sealing ridge and groove arrangement 36 is provided between the outer surface of skirt 28 and the inner surface of flange 34 to further assist in sealing the interior of the valve body. The nested arrangement of body 26 within the base 32 defines a cavity 34 through which water flows when admitted into inlet valve 20.

Body base 32 is provided with a ribbed inlet nozzle 40 having spaced apart ribs for receiving thereon the other end of the flexible hose from nozzle 4 so that the two nozzles 4,40 are in fluid communication with one another allowing water to be admitted to inlet valve 20 from the mains pressure supply in use. The flexible tubing between nozzles 4 and 40 allows the height of the inlet valve 20 to be adjusted on post 14 while still remaining connected and in fluid communication. A outlet nozzle 80 is provided at one location in side skirt 28 as shown in FIG. 4. The location of outlet nozzle 80 is generally at about 90 degrees to the line containing arm 22. Outlet nozzle 80 is provided with a plurality of spaced apart ribs 82 for being received in one end of a discharge tube for directing water from valve 20 into the cistern. However, it is to be noted that outrigger 44 can extend at any angle to arm 22 as required. Furthermore, outrigger 44 may be fixed or may be rotationally adjustable to alter the angle of extension from inlet valve 20

An outrigger 44 is provided diametrically opposed to arm 22 and extends radially outwardly in the opposite direction to arm 22 from side skirt 28 above body 26. A pivotable float 46 is pivotally connected to the distal end of the outrigger 44 by a pivotable connection or similar 48. It is to be noted that float 46 is provided with an indentation 49 or internally directed bore for receiving the distal end of outrigger 44 so that float 44 remains air tight whilst connected to outrigger 44 and whilst pivoting.

A generally rod like plunger 50 is received in the upwardly extending narrow bore 30 of the upper part 31 of the valve body 26 for axial movement therein. It is to be noted that plunger 50 is freely moveable within bore 30 to allow air to pass between plunger 50 and bore 30 in use. A retaining cap 52 is located on top of the bore 30 to retain seal 54 at the top of extension 31 to seal plunger 50 to valve body 26. Seal 54 can take a number of different forms. One form is a sealing ring, such as an “O” ring which provides sealing of plunger 50 within bore 30. Other forms of the seal include hydraulic sealing rings, gaskets or the like. Cap 52 maintains seal 54 in place.

A clearance portion 51 is provided at one or more locations along the length of plunger 50. In one form clearance 51 takes the form of a reduced diameter neck or waist portion having tapered side edges. Clearance portion 51 allows air egress into the interior of valve 20 particularly into and through cavity 38. Neck 51 provides the air lock capability of the inlet valve of the present invention.

Cavity 38 is formed between side skirt 28 of valve body 26 and flange 34 of valve body 26. Upper sealing ring retainer 56 is provided in the upper portion of cavity 38 and retains a pair of sealing rings 58,60 for sealing the valve in use. In one form upper sealing ring retainer 56 is provided with four spaced apart legs defining apertures or openings therebetween allowing air to pass through the walls of retainer 56. It is to be noted that upper sealing ring retainer 56 can adopt any suitable shape, form or configuration that allows air to pass through the walls to form part of the air lock arrangement. Further it is to be noted that cavity 38 is in fluid communication with discharge nozzle 80 allowing air to flow into through and out of the inlet valve to permit anti-siphoning within the cistern.

A bottom sealing ring retainer 62 is located immediately adjacent upper sealing ring retainer 56 to complete sealing of the inlet valve when in the closed position using sealing ring 64 to contact the inside of body base 32.

A connector in the form of a connector block 53 is located at or towards the proximal end of plunger 50 above inlet valve 20. Connector block 53 has a bore and pin arrangement 55 for pivotally connecting the plunger 50 to one end of link 57. The other end of link 57 is pivotally connected to one end of lever 68 through a pin and aperture arrangement 59.

The lever 68 is pivotably mounted about a fulcrum 69 provided at or towards the top of pillar 70. The lower end of pillar 70 is fixedly attached to a central portion of outrigger 44. The other end of lever 68 is pivotably connected to one end of a second lever 72 which in turn is pivotably connected at the other end to a spigot 74 provided on the top surface of float 46.

Operation of the valve arrangement will now be described.

In operation of the valve arrangement including the inlet valve of the present invention when the cistern is empty after flushing the level of the water in the cistern will be low, such as for example about the level of foot 10 of bracket 12 located at the lower wall 8 of the cistern.

In this position float 46 will have pivoted downward so that spigot 74 is lowered causing levers 72 and 68 to pivot accordingly to raise plunger 50 so that the distal end of plunger 50 is raised so as to be removed from being located between sealing “O” rings 58,60 to a position as shown in FIG. 1 and FIG. 4. With the plunger in this position as shown in FIGS. 1 and 4 water under mains pressure is admitted through nozzle 4 and the flexible tube to enter inlet nozzle 40 of inlet valve 20 to flow through cavity 38 so as to be discharged through outlet 80 into the cistern so as to replenish the cistern.

This condition is maintained as the water level rises within the cistern. The water level within the cistern rises until float 46 begins to float on the surface of the raising water level to pivot about pivot 48 owing to the effect of buoyancy so that spigot 74 begins to rise in accordance with upward pivotable movement of float 46. This in turn moves levers 72,68 to push plunger 50 downwardly so that the distal end moves between sealing O rings 58,60 as shown in FIG. 3 to close the inboard opening of inlet nozzle 40 thereby preventing additional water from entering cavity 38 and being discharged through outlet 80 into the cistern. As float 46 moves almost instantaneously as the level of water rises, plunger 50 in effect snaps positively closed to almost instantaneously stop the flow of water through inlet valve 20. Thus, there is no gradual closure of the inlet valve but rather an instantaneous shut off which reduces noise, leaking and promotes effective sealing of the inlet valve.

Simultaneously with plunger 50 moving downwardly to adopt the position as shown in FIG. 3 clearance portion 51 aligns with sealing ring 54 so that there is a clearance between the wall of plunger 50 and sealing ring 54 allowing air to enter into the top of bore 30 of valve body 26 and to pass along the length of the bore into cavity 38. As the walls of upper sealing ring retainer 56 are not continuous but rather are provided with large open areas air can flow readily through cavity 38 past the walls of retainer 56 to thus equalise pressure inside and outside the inlet valve 20 which has the effect of forming an air gap as the level of discharge water in the outlet falls by atmospheric pressure to the level of the water in the cistern when the cistern is full thereby preventing siphoning of water through the valve from the cistern into the inlet 4 and thus into the water supply.

This condition is maintained until the cistern is flushed whereupon water is discharged through an outlet of the cistern (not shown) into the toilet bowl causing the level of water within the cistern to fall towards the level of foot 10 of bracket 12 thereby allowing float 46 to pivot downwardly which raises the plunger 50 allowing replacement water to replenish the cistern as previously described.

In FIGS. 5 to 8 is shown another form of the inlet valve. In the arrangement shown in FIGS. 5 to 8 similar reference numerals will be used to denote corresponding features to the valve arrangement of FIGS. 1 to 4. This form of the valve arrangement is generally denoted as 102 and includes an inlet nozzle 4 having a reduced diameter portion 6 for receiving the flexible hose. Support bracket 12 has a post 14 in the same manner as the previously described valve 20. The form of the inlet valve of arrangement 102 is generally denoted as 120 and is provided with a radially outwardly extending arm 122 having an aperture 24 located at or toward the distal end of the arm. When the aperture 24 of arm 122 is aligned with one of the apertures 18 of post 14 a pin can be received through the aligned apertures 18, 24 to mount or attach valve 120 to support bracket 12 at the desired height in order for the valve arrangement 102 to be accommodated in a particular type, style, or size cistern in which it is desired to mount the valve. The proximal end of arm 122 is attached to a generally cylindrical lower valve body 132. Lower valve body 132 is provided with nozzle 140 for connection by conduit 142 to nozzle 6. Outlet 180 is located in substantially parallel spaced apart relationship to inlet nozzle 140. During filling of the cistern water is discharged through nozzle 180 into a flexible hose or conduit 182 and then to a shower rose 184 or similar to fill up the cistern.

A sealing ring 158 is located in the upper end of the bore formed by nozzle 140. The upper portion of lower valve body 132 is provided with a flange 191, located around the upper edge of side wall 130 of lower valve body 132.

A substantially cylindrical upper valve body 126 is provided with a side wall portion 128 which depends downwardly so as to be received inside of upwardly extending side wall 130 of lower valve body 132. A sealing groove and ridge arrangement 136 is provided between upper body 132 and lower body 126 to maintain them securely and sealingly together. Shoulder 129 is provided to form the upper surface of upper body 132 from which extends upwardly elongate boss 131. In use the upper body member 126 is received in lower body member 132 so that the outer surface of side wall 128 of the upper body member 126 abuts against the inside surface of side wall 130 of the lower body member 132. A cavity 138 is formed between the upper and lower body members.

A plunger guide 160 is located internally in the bore 130 of upward extension 131 and is sealed thereto with sealing ring 154. A lengthwise extending channel 192 is provided along one side of the inner wall forming bore 131 to allow air flow between plunger 50 and bore 131 when the valve 120 is in a closed position. A radially extending aperture or bore 170 is provided in the side wall of guide 160 and is in fluid communication with cavity 138 formed between the upper and lower valve body members. In one embodiment there is a single radial aperture whereas in other embodiments there are two diametrically opposed radial bores. Other embodiments can have other arrangements and/or number of bores, apertures etc. In use plunger 50 moves axially within the bore 131 of guide 160. Plunger 50 is provided with a reduced diameter neck or waist clearance portion 51. A connector block 153 is provided at the top of plunger 150 and is connected to one end of lever 168 which is pivotally connected to post 170 at fulcrum 171. The other end of lever 168 is connected to spigot 74 of float 46. The pivotal connections at either end of lever 168 are provided with slots.

The ends of levers 168 are provided with slots allowing loose pivotally connection of the ends of lever 168 to float 46 and connector block 153.

In operation of this form of the inlet valve, when inlet valve 120 is in an open position water flows from nozzle and through conduit 142 to inlet nozzle 140 up through bore 130 and through ports 170 into cavity 138 and out through nozzle 180 into hose 182 to be discharged into cistern through shower rose 184 located at, towards or on the base wall of the cistern. When the cistern is full plunger 50 is forced downwards so that bore 130 is sealed by the distal end of plunger 50 being received through sealing ring 158. With the plunger 50 in this position air can flow past clearance portion 151, down through lengthwise extending channel 192 and through ports or bores 170 into cavity 138 whereupon the air pressure inside valve 120 is the same as outside valve 120 so that water flows through outlet 180 into the cistern to form an air gap, mainly in cavity 138 which is located above the level of water in the cistern, when the cistern is full.

Advantages of the present invention include that the size of the valve 2 can be selectively adjusted to fit into a greater variety of different cisterns. Fluid communication between the inlet to the cistern and the inlet to the valve is always maintained by the flexible hose irrespective of the size of the valve arrangement. The valve arrangement is provided with an air lock preventing unwanted siphoning of water into the mains supply thereby preventing contamination of the mains supply water.

One advantage of the present invention is being able to produce a flush system as a water saving device to be used in countries where water is a precious resource. This applies also at start up of new sewerage systems by applying standards requiring the use of water sawing flush systems. The water saving could also reduce the size of purification plants downstream. Another advantage is that both inlet and outlet can be used as stand alone replacement items.

It will be understood to persons skilled in the art of the invention that many modifications may be made without departing from the spirit and scope of the invention.

Those skilled in the art will appreciate that the invention described herein is susceptible to variations and modifications other than those specifically described. It is understood that the invention includes all such variations and modifications which fall within the spirit and scope.

1. An inlet valve controlling the introduction of fluid into a vessel, said vessel forming a reservoir for the fluid and having an inlet admitting replacement fluid from a fluid supply into the vessel to replace fluid discharged from the vessel by flow of fluid from the supply inlet of the vessel through the inlet valve, said inlet valve comprising a valve body member and a movable valve element that is movable with respect to the valve body member between a first position corresponding to a closed condition preventing flow of fluid through the inlet valve and a second position corresponding to an open condition allowing a flow of fluid through the inlet valve to replenish or replace the supply of fluid within the vessel after discharge of fluid from the vessel wherein there is a clearance portion associated with the valve body member or the movable element, said clearance portion being arranged such that when the movable element is in closed position within the inlet valve there is a space or gap between the movable element and valve body member allowing flow of gas into and/or through the valve between the movable element and the valve body member so as to provide a facility of or for a gas gap in the valve wherein the gas gap prevents unwanted flow of liquid from the vessel into the supply of fluid when the inlet valve is in the closed position.

2. An inlet valve according to claim 1 wherein the vessel is a cistern of a toilet.

3. An inlet valve according to claim 2 further comprising an adjustable support member for adjusting the mounting of the valve within the cistern.

4. An inlet valve according to claim 1 wherein the movable valve element is a substantially elongate member.

5. An inlet valve according to claim 4 wherein the elongate member is a plunger, cylindrical rod, bar, shaft or similar.

6. An inlet valve according to claim 1 wherein the movable valve element has a sealing end being curved, rounded, tapered, or beveled.

7. An inlet valve according to claim 6 in which the sealing end of the movable valve element sealingly engages with a complementary sealing means provided on or associated with the valve member to close the valve to prevent incoming water from flowing into the valve.

8. An inlet valve according to claim 1 wherein the valve further comprises an operating mechanism including one or more levers pivotally connected together and connected to the movable valve element such that movement of one or more of the levers moves the movable valve element.

9. An inlet valve according to claim 1 wherein the clearance portion is a space, gap, looseness of fit, clearance, cut-out, rebate, groove, indent or similar located at one or more points or regions along the length of the movable valve element allowing air to flow past and/or through the clearance to reduce siphoning of water from the cistern.

10. An inlet valve according to claim 1 wherein the clearance portion is located at or towards the central portion or region of the movable valve element or at or towards one end of the movable valve element.

11. An inlet valve according to claim 1 wherein the movable valve element is provided with a reduced size or diameter portion such as for example a neck portion or waist portion allowing air to flow between the movable valve element and the valve body.

12. An inlet valve according to claim 5 wherein the clearance is located on or around the outside surface of the plunger.

13. An inlet valve according to claim 1 wherein the clearance portion is continuous or is segmented having portions defining gaps or spaces therebetween.

14. An inlet valve according to claim 1 wherein a plunger is associated with a plunger guide housing or shroud.

15. An inlet valve according claim 14 wherein the plunger guide housing or shroud is provided with a channel, groove, reduced bore portion, rebate, aperture or the like for providing clearance between the plunger.

16. An inlet valve according to claim 2 wherein the inlet valve is adjustably locatable within the cistern.

17. An inlet valve according to claim 2 wherein the inlet valve includes an element responsive to changes in the water level within the cistern.

18. An inlet valve according to claim 17 wherein the element responsive to changes in the water level is responsive to the effective buoyancy and/or gravity.

19. An inlet valve according to claim 1 wherein the responsive element is a float which is pivotally connected to the valve arrangement.

20. An inlet valve according to claim 19 wherein the float moves with a flip action or positive snap action to substantially instantaneously close the supply of incoming water.

21. An inlet valve according to claim 1 wherein there is an air gap within the inlet valve to prevent siphoning of back flow of water within the cistern so as to reduce, eliminate or prevent contamination of the water supply.

22. (canceled)
